(19) United States
(12) Patent Application Publication
(10) Pub. No.: US 2015/0217598 A1
(43) Pub. Date: Aug. 6, 2015

(54) WHEELED VEHICLE WITH PATTERN LIGHTING

(71) Applicant: NEXTSPORT, INC., Emryville, CA (US)

(72) Inventors: Ed Dua, Washington, DC (US); Martin Dalgaard, Topanga, CA (US)

(73) Assignee: NEXTSPORT, INC., Oakland, CA (US)

(21) Appl. No.: 14/172,671

(22) Filed: Feb. 4, 2014

(51) Int. Cl. B60B 7/00; B60B 7/20

(52) U.S. Cl. CPC B60B 7/006; B60B 7/20

(57) ABSTRACT

A wheeled vehicle, such as a tricycle includes a wheel and a disc mounted on the same axle so that the disc is free to rotate separately from the wheel. The disc includes a plurality of lighting elements substantially along a line formed by a radius of the disc. Each of the lighting elements is lit or unlit as the disc rotates according to the rotational position of the disc. In this manner the illusion of a pattern or picture is made when the disc is rotated at a sufficient speed. A drive mechanism, such as a traction wheel driven by the wheel connected by a belt to the hub of the disc, causes the disc to rotate at a rate that is a multiple greater than the rotation rate of the wheel.

### BACKGROUND

Tricycles are common self-propelled ride-on wheeled vehicles most commonly ridden by children. Of course, tricycles have three wheels. In addition, most have one relatively large, steerable wheel in the front with pedals directly connected to the front wheel's axle. They also usually have two smaller wheels with a common axle or with common or parallel axes in the rear. The front wheel is relatively large because the pedals are fixed to the front wheel axle—they are not geared. Thus, the larger the front wheel, the farther the tricycle will go for each revolution of the pedals. The front wheel also has to be large enough so that the pedals and feet on the pedals clear the ground when being pedaled.

The classic children's tricycle has a metal frame with front and rear wheels as described above and a seat located at about the level of the top of the front wheel, between the front axle and the rear axle (in other words, noticeably forward of the rear axle). Another popular type of children's tricycle was popularized in the early 1970s under the trademark “Big Wheel,” (apparently owned by Alpha International, Inc.). As shown in FIG. 1, this type of tricycle (hereinafter, “low slung tricycle”) also has front and rear wheels as described above. However, unlike the classic children's tricycle, the low slung tricycle has a seat located between the rear wheels, atop the rear axle, at a level typically lower than the top of the rear wheels. The low slung tricycle is also typically made of plastic.

### SUMMARY

A wheeled vehicle, such as a tricycle, includes a wheel and a disc mounted on the same axle so that the disc is free to rotate separately from the wheel. The disc includes a plurality of lighting elements substantially along the line formed by a radius of the disc. Each of the lighting elements are lit or unlit as the disc rotates according to the rotational position of the disc. In this manner, the illusion of a pattern or picture is made when the disc is rotated at a sufficient speed. A drive mechanism, such as a traction wheel driven by the wheel connected by a belt to the hub of the disc, causes the disc to rotate at a rate that is multiple times greater than the rotation rate of the wheel.

### BRIEF DESCRIPTION OF THE DRAWINGS

FIG. 1 is a perspective view of a three wheeled vehicle.

FIG. 2 is a view of the front wheel of a three wheeled vehicle according to an embodiment of the invention.

FIG. 3 is an exploded view of the front wheel of a three wheeled vehicle according to an embodiment of the invention, similar to the wheel shown in FIG. 2.

### DETAILED DESCRIPTION

In an exemplary embodiment, a riding vehicle has one large front wheel and two small rear wheels. In many embodiments the rider sits on a seat mounted between the rear wheels. In many embodiments, the front wheel is steerable and has pedals that allow the rider to propel the vehicle. As shown in FIG. 2, a substrate (a disc 100 in the embodiment shown in FIG. 2) is mounted next to the front wheel 110 on the same axle 120 (and axis) as the wheel. The disc 100 is connected to the axle through bearing 175. Typically, the center of rotation of the bearing (the axis of the bearing) coincides with the longitudinal axis of the axle. Mounted in this manner, the disc is able to rotate independently of the rotation of the wheel. The wheel includes a contact portion 115 around its perimeter where the wheel usually comes in contact with the ground. In many embodiments the disc has a generally circular a perimeter 105, but in other embodiments the disc has other shapes, but for convenience, the term “disc” in this application is meant to cover any shape, whether it's perimeter is circular, has rounded portions, or neither.

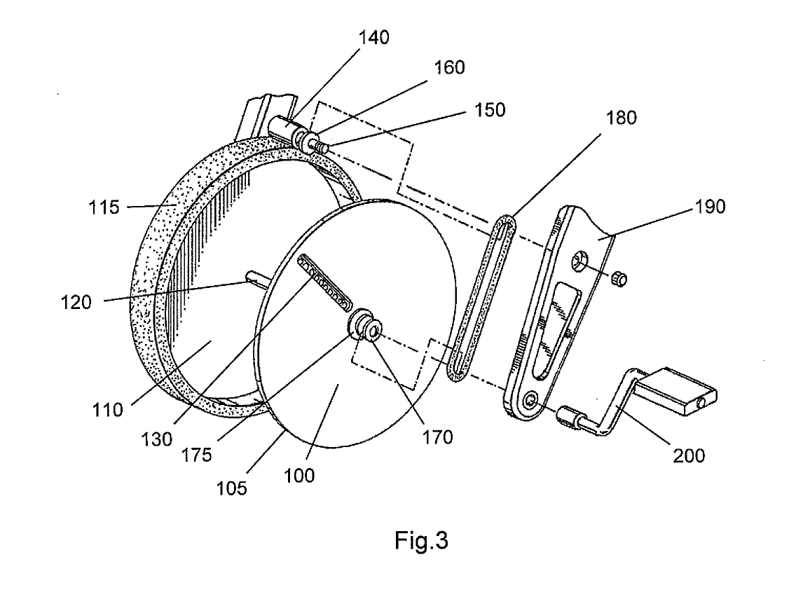

FIG. 3 shows an exploded view of an embodiment corresponding to FIG. 2. FIG. 3 also shows the front wheel fork 190 and a pedal 200. In embodiments in which the axle 120 rotates with the front wheel (for example if there are bearings in the front wheel fork), the pedal is connected to the axle. In embodiments in which the axle 120 does not rotate with the front wheel (for example, a fixed axle), the pedal is connected to the wheel side of a bearing connecting the wheel to the axle or is connected to the wheel itself.

The disc has a row of lighting elements 130 (“light strip”) that radiate in a line from the axis towards the perimeter of the disc. In many embodiments the lighting elements are aligned substantially on a radius of the wheel. In other embodiments, the lighting elements are in any arrangement such that different lighting elements are different distances between the center and perimeter of the disc. In such embodiments, the lighting elements may not be in a “strip” but, for convenience, any arrangement of lighting element at varying distances between the center and perimeter of the disc will be referred to in this application as a “light strip.”

In many embodiments, the lighting elements are LEDs, but in some embodiments other lighting elements, such as incandescent bulbs and fluorescent bulbs are used. In some embodiments the lighting elements are multicolored LEDs or other multicolored lighting elements so that each of the lighting elements can produce any desired color.

Lighting elements arranged in this or a similar manner can produce the illusion of a pattern or picture covering a large portion of the area of the wheel when the wheel rotates at an adequate speed. This is accomplished by lighting individual lighting elements at the same position every time the wheel rotates. For example, the position of the light strip can be identified by the number of degrees the light strip is compared to a predefined rotational position, such as top dead center. In this example, the last element on the light strip may be lit every time the wheel is rotated 10-15, 20, and 25-30 degrees from top dead center, but not lit every time the wheel is rotated to any other degrees from top dead center. In this manner, if a strip of 10 lights and 360 rotational positions are used, the rotating image can be characterized as having 3600 pixels (ten pixels for each degree). The resolution of the pattern can be increased or decreased by increasing or decreasing the number of lights in the light strip and/or increasing or decreasing the number of rotational positions at which each light can be lit or unlit. Animated pictures/patterns can be produced by using different pictures/patterns in successive rotations of the wheel.

Typically, the control of the lighting of the individual elements of the light strip is controlled by a processor (not shown). In various embodiments, the processor can be preprogrammed with a particular pattern/picture; can be preprogrammed with a number of particular patterns/pictures and have an input by which a user can change between the preprogrammed patterns/pictures; can be programmable by a user using an input; or some combination of these. In some embodiments, the processor is programmable through a wireless connection, such as Bluetooth.

The disc includes a sensor (not shown) that determines the position of the light strip relative to a fixed point in the rotation of the disc. In many embodiments, the fixed point is a point on the line extending from the axle of the disc straight upward. In some embodiments the sensor is a gravity switch that closes when a pendulum in the switch reaches the bottom of the sensor. In some embodiments the gravity switch uses a conductive liquid, like mercury, that closes contacts when the sensor is rotated to a particular position. In some embodiments the sensor is a multi-axis accelerometer that is used to measure the rotational position of the disc as well as the rotational speed. In many of these embodiments an accelerometer is used of the type commonly used in smart phones.

In some embodiments the sensor detects a magnetic field produced by a magnet attached to the inside of the fork 190 that holds the wheel. Alternatively some portion of the wheeled vehicle, such as the fork, includes a protrusion that closes contacts on the disc, adjacent to the protrusion, once every time the disc rotates. In other alternatives, anything that can be sensed by a sensor (e.g., light) is used. In some of these embodiments the position of the sensor and the thing being sensed (e.g., magnet, protrusion) are reversed so that the sensor is mounted at a fixed position relative to the disc and the thing being sensed rotates with the disc. In some embodiments the sensor and the thing being sensed are both on either the disc or at a fixed position relative to the disc but the sensor can only detect the thing being sensed at a particular point in the rotation of the disc, such a an opening that reveals a reflector that reflects a light on the disc to the sensor only at a particular point in the rotation of the disc. In some embodiments more than one sensor and/or more than one thing being sensed are used. In this way, changes in the rotational speed between full revolutions of the disc can be sensed and adjustments in the advancing or retarding of the lighting and non-lighting of the lighting elements can be made more than once per revolution.

An example of a strip of lights on a cycle wheel that makes changeable patterns when the wheel rotates is described in U.S. Pat. No. 5,800,039 to Lee et al., which is incorporated by reference as if fully set forth herein.

In various embodiments the light elements, processor, and sensor are powered by a battery, a generator driven by the front wheel 110, a solar cell, or a combination of these or other devices that produce a sufficient electric current. In many embodiments a switch connects the power source to the powered devices so that the lighting system can be turned on and off. In some embodiments the switch is a centrifugal switch that closes when the disc rotates at or greater than a particular rotational speed.

In order for the lighting elements on the disc to create the illusion of a pattern, alphanumeric characters, or picture, the disc must rotate at or above a certain minimum speed. During normal operation the front wheel of the tricycle will not rotate at or above this minimum speed. To make the disc rotate at or above the minimum illusion speed, the vehicle includes a traction wheel 140 affixed to the vehicle so that the rotation of the front wheel causes the traction wheel to rotate faster than to the rotation speed of the front wheel. The traction wheel typically has a much smaller radius than the front wheel and thus will rotate many times faster than the front Wheel. In many embodiments, the traction wheel is connected by an axle 150 to a first pulley 160 so that the first pulley rotates substantially in unison with the traction wheel. The vehicle has a second pulley 170 that is connected to the disc so that the second pulley rotates in unison with the disc. In some embodiments the second pulley is connected directly to the disc side of the bearing 170. In some embodiments the second pulley is integral with the bearing 170. The first and second pulleys are connected to each other by a flexible belt 180 that does not generally slip relative to the pulleys. In some embodiments, the belt is an elastic band such as a band made of rubber. In other embodiments, the belt is made of a flexible polymer. In other embodiments, the band is a chain similar to those used for propulsion of bicycles.

The ratio of the radius of the front wheel to the radius of the traction wheel determines how much faster the disc rotates than the wheel. In various embodiments, the diameter of the first pulley is different than the diameter of the second pulley. If the first pulley has a greater diameter than the second pulley, the ratio between the rotational speed of the disc to the wheel will be increased, and if the first pulley has a lesser diameter than the second pulley, the ratio between the rotational speed of the disc to the wheel will be reduced. In many embodiments, the diameter of the first pulley is greater than the diameter of the traction wheel and the diameter of the second pulley is less than the diameter of the traction wheel. In these various embodiments, the sizes of the traction wheels and pulleys are selected so that a minimum illuminated pattern rotational speed is achieved at or below the typical rotation speed of the front wheel in operation.

In some embodiments, pulleys are not used. In some of these embodiments, a first bevel gear (not shown) is connected to the axle 150 of the traction roller 140 and a second bevel gear (not shown) is attached to the disc 100, or disc side of the bearing 175. A rotating rod with bevel gears on both ends, one engaged with the first bevel gear and the other engaged with the second bevel.

In some embodiments, a traction wheel is not used. Rather, the bearing 175 is replaced with a geared hub with an internal planetary gear train (not shown). The central (or sun) gear of the planetary gear train is attached to the front wheel or something that rotates with the front wheel (such as the axle in a rotating axle system) so that the central gear and the front wheel rotate together in a fixed relationship. The outer (or annular) gear is attached to the disc or something that rotates with the disc so that the outer gear and the disc rotate together in a fixed relationship. The geared hub contains internal gearing (planet gears) that causes the outside of the geared hub (outer gear) to rotate faster than the axle and thus causes the disc to rotate faster than the front wheel.

In some embodiments the disc is rotated by an electric motor, either completely or with assistance from the pedals. In many of these embodiments the operation of the motor is activated by a user operated switch or a centrifugal switch that closes when the front wheel is rotating at a predetermined minimum speed.

In many embodiments, the disc is connected to its axle by a ratcheting mechanism that causes the disc to rotate in the same direction that the axle is rotating when the axle rotates in one direction, but allows the disc to continue to rotate in the first direction when the axle's rotation slows, stops, or reverses.

In some embodiments, the traction wheel and the disc axle are connected through a centrifugal clutch. In a typical tricycle, the force on the pedals required to get the tricycle moving from a stop is considerably more than the force required to maintain or moderately increase the velocity of a moving tricycle. With a tricycle of the embodiments described herein, an additional amount of force must be used to make the disc rotate at a faster rate than the front wheel than is required just to make the front wheel rotate. This additional force must be supplied through the pedals. The additional force required may not be large, but it will be at least noticeable. The amount of additional force required will depend on a number of factors, including the mass of the disc, the friction associated with the movement of the disc, the efficiency of the gearing of other components used to make the disc rotate, and the ratio of the speed of the disc's rotation to the front wheel's rotation. When the tricycle is moving, this additional force required to rotate the disc is comparatively small. However, as with the force needed to get a tricycle moving from a stop, the additional force needed to get the disc moving from a stop is much more significant. When the front wheel and the disc are connected via a centrifugal clutch, little or no force from the pedals is applied to the disc when the front wheel is stopped, but as the front wheel rotates faster and less force is required to be applied to the pedals for the front wheel, the centrifugal clutch gradually applies more of the force from the pedals to the disc.

In some embodiments the disc is not solid, but rather is spoked. In some embodiments, in place of a disc, the light strip is attached to a single spoke that has one end attached at the bearing, hub, pulley, some other point near the center of the disc. The other (outer) end of the spoke is directed generally toward the perimeter of the disc. In some embodiments the end of the spoke is not attached to anything, but simply rotates around the axle of the front wheel like a fan blade. Accordingly, in such embodiments, more than one spoke may be used, with or without a light strip to counterbalance the first spoke. In some embodiments the outer end of the spoke fits into a circular track that is attached, for example, to the front wheel or to the front fork. Such a track lessens the likelihood that the outer end of the spoke may be accidentally bent sideways away from the wheel.

In some embodiments both sides of the front wheel have a separate disc, each with a light strip. The pattern or picture displayed by the light strip can be the same on both sides or different. In some embodiments the front wheel is not solid, but is spoked or has numerous cut out portions. In such embodiments, a single disc may have a light strip on both sides of the disc so that a lighting strip can be seen from both sides of the front wheel. In some embodiments a single disc may have a single light strip that is arranged in a way so that each of the lighting elements can be seen from both sides of the front wheel. In embodiments in which the front wheel is spoked such that some spokes attach to the right side of the hub/axle of the front wheel and some spokes attach to the left side of the hub/axle of the front wheel, as in a traditional bicycle wheel, the disc is mounted between the spokes that attach to the right side of the hub/axle and the spokes that attach to the left side of the hub/axle.

It will of course be appreciated that a disc with a light strip of various of the embodiments described can be implemented on vehicles with any number of wheels, including bicycles—not just three wheeled vehicles.

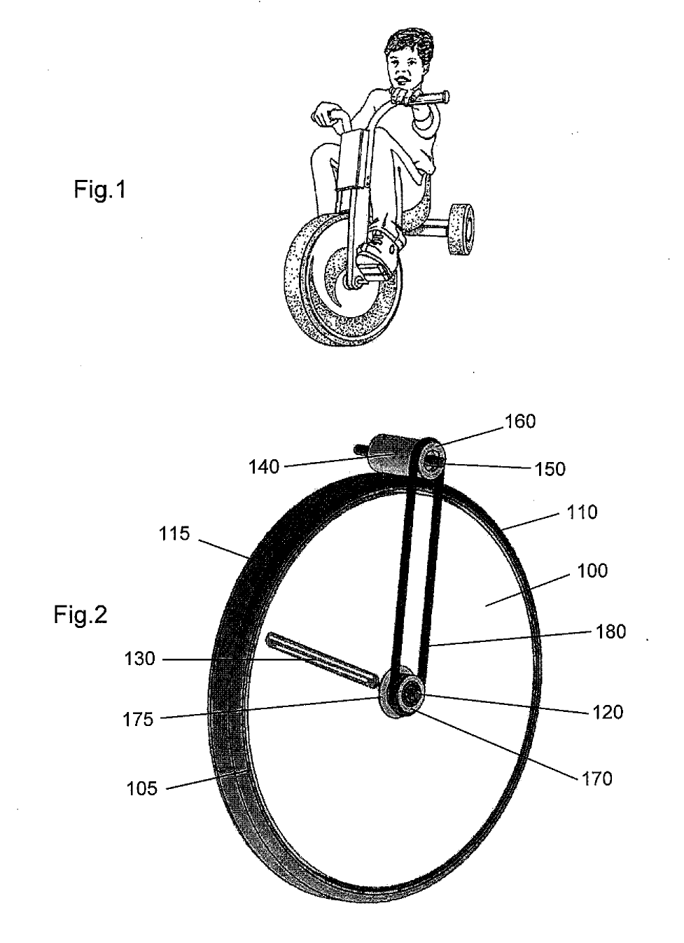

In some embodiments a disc with a light strip as in many of the embodiments described is mounted on a wheel not directly powered by the user, such as the rear wheels on a traditional tricycle or a low slung tricycle like the one shown in FIG. 1.

It will also of course be appreciated that a disc with a light strip various of the embodiments described can be mounted offset from or in a different location from the front wheel. In other embodiments the disc is not mounted in parallel with the front wheel. In some of these embodiments the disc is mounted so that it is perpendicular to the front wheel so that the pattern is displayed primarily to the front or rear of the vehicle, such as the orientation of a traditional front or rear safety reflector.

What is claimed is:

1. An apparatus for use with a wheel with an axle, the apparatus comprising:
a disc rotatably mounted on the axle so that the disc is free to rotate separately from the wheel;
a plurality of lighting elements attached to the disc substantially along a single radius of the disc, wherein each of the lighting elements are lit or unlit according to the rotational position of the disc; and
a drive mechanism that causes the disc to rotate at a rate that is a multiple of the rotation rate of the wheel, the multiple being greater than one.

2. The apparatus of claim 1 wherein the drive mechanism comprises:
a traction wheel mounted adjacent to the outside of the wheel so that rotation of the wheel causes the traction wheel to rotate;

3. The apparatus of claim 2 wherein the drive mechanism further comprises:
a traction wheel pulley connected to the traction wheel;
a disc pulley connected to the disc; and
a belt connecting the traction wheel pulley to the disc pulley.

4. The apparatus of claim 2 wherein the drive mechanism further comprises:
a traction wheel bevel gear connected to the traction wheel;
a disc bevel gear connected to the disc; and
a rod with a first bevel gear that engages the traction bevel gear and a second bevel gear that engages the disc bevel gear.

5. The apparatus of claim 1 wherein the drive mechanism comprises a planetary gear between the wheel and the disc.

6. The apparatus of claim 1 further comprising a processor electrically connected to the lighting elements, wherein the processor is configured to control lit and unlit states of the lighting elements dependent on the rotational position of the disc.

7. The apparatus of claim 6 further comprising a rotational position sensor operably connected to the disc and to the processor.

8. The apparatus of claim 6 wherein the lighting element is lit and unlit under control of the processor create the optical illusion of a pattern covering a substantial portion of the disc.

9. The apparatus of claim 8 wherein the multiple of the disc's rotation to the wheel's rotation is great enough so that the disc rotates at sufficient speed to create an optical illusion of a pattern from the lighting elements.

10. The apparatus of claim 1 further comprising:
a second disc mounted on the opposite side of the wheel; and
a second plurality of lighting elements attached to the second disc.

11. The apparatus of claim 10 wherein the second disc is caused to rotate by the drive mechanism.

12. The apparatus of claim 10 further comprising:
a second drive mechanism that causes the second disc to rotate.

13. The apparatus of claim 1 further comprising:
A ratcheting mechanism mounted between the drive mechanism and the disc so that the disc continues to rotate free of the drive mechanism when the drive mechanism slows or stops.

14. The apparatus of claim 1 wherein a plurality of the lighting elements comprise LEDs.

15. The apparatus of claim 1 wherein a plurality of the lighting elements comprise multichromatic LEDs.

16. The apparatus of claim 1 further comprising the wheel.

17. A wheeled vehicle including the apparatus of claim 1 mounted on at least one wheel.

18. The wheeled vehicle of claim 17 wherein the wheeled vehicle is a tricycle.

19. The wheeled vehicle of claim 17 wherein the wheeled vehicle is a bicycle.

20. An apparatus for use with a wheel with an axle, the apparatus comprising:
A bearing mounted on the axle, wherein a portion of the bearing does not rotate with the axle or the wheel;
a substrate including a plurality of lighting elements located at varying distances from the center of the bearing, the substrate having an inner portion connected to the portion of the bearing that does not rotate with the axle or the wheel and an outer portion that is further from the center of the bearing than the inner portion, the outer and inner portions of the substrate are configured to rotate at substantially the same rotational rate around the center of the bearing, and wherein each of the lighting elements are lit or unlit according to the rotational position of the substrate; and
a drive mechanism that causes the substrate to rotate around the center of the bearing at a rotational rate that is a multiple of the rotation rate of the wheel around the axle, the multiple being greater than one.
